(19) United States
(12) Patent Application Publication
(10) Pub. No.: US 2012/0175330 A1
(43) Pub. Date: Jul. 12, 2012

(54) ROD HOLDER

(75) Inventors: Matthew Nicholls, Denver, NC (US); David M. Stitchick, Akron, OH (US); Robert John Warner, JR., Charlotte, NC (US)

(73) Assignee: RUBBERMAID, INC., Huntersville, NC (US)

(21) Appl. No.: 12/986,256

(22) Filed: Jan. 7, 2011

(51) Int. Cl. A47F 5/08; B29C 45/14; F16M 13/02; F16M 13/00; F16B 45/00

(52) U.S. Cl. 211/90.01; 248/251; 248/205.1; 248/225.21; 264/279

(57) ABSTRACT

A rod holder that for supporting a hanger rod in a shelving system. The hanger rod holder includes at least two materials, with a central plate that may be made of metal that may be substantially encapsulated in molded plastic. The hanger rod holder is mounted to a shelf bracket, and may be used with either solid or wire shelving systems. The low end of the holder engages a hanger rod, and may be configured to resiliently cradle the rod, with the rod being held in place in the holder by spreading the resilient ends of a C-shaped opening in the lower end of the holder.

### BACKGROUND

The rod holder disclosed herein relates generally to the field of shelving, and particularly may relate to support of a hanger rod from modular shelving.

Hanger rod holders are known that are made mostly of metal, while others are made from plastic materials. Some rod holders are entirely metal, but these require manufacture to very strict tolerances on both the rod and the holder. For the most part, to hold a rod immobile, a metal product requires the use of discreet plastic parts interposed between the metal and the rod to get a snug fit with the rod. Metal holders generally are not flexible and accept only one diameter of rod, and the metal is part of the holder portion that extends at least part way around the rod.

An alternative approach is a holder made entirely of plastic. Plastic products may immobilize the rod, but to avoid creep over time when exposed to high temperatures, plastic holders require large amounts of resin. All-plastic holders are often used with wire shelving, as the holders may be attached to the shelving at relatively close intervals, reducing the load on each holder. Plastic holders, however, lack adequate strength to be used with a shelf bracket that supports both wood or wire shelves, as the holders are then placed at intervals determined by bracket spacing and may break as the result of the limited area of support that the brackets provide.

### SUMMARY

In accordance with one embodiment described herein, a holder for a rod is provided. The holder includes a plate made of a first material. The plate includes a plate body and mounting means extending from the plate body. A second material encapsulates the plate body and forms an end element configured to receive the rod. In some embodiments, the first material may be metal, such as steel, and the second material may be plastic, such as a molded plastic.

In accordance with another embodiment described herein, support apparatus for a rod is provided. The support apparatus includes a bracket that is adapted to be mounted to a wall defining an opening, and a holder. The holder includes a plate made of a first material. The plate includes a plate body and mounting means extends from the plate body. The mounting means are adapted to be received in the opening in the bracket. A second material encapsulates the plate body and forms an end element configured to receive the rod. In some embodiments, the bracket and holder may be used to support a rod for a support apparatus that includes a solid shelf and for a support apparatus that includes a wire shelf.

In accordance with another embodiment described herein, a method of making a hanger rod holder is provided. The method includes providing a plate having a body and mounting means extending from the body, and molding plastic to encapsulate the body of the plate and to form an end for receiving the rod. The end for receiving the rod may include a C-shaped element.

### BRIEF DESCRIPTION OF THE DRAWINGS

For a more complete understanding of the dispenser described herein, reference should now be had to the embodiments shown in the accompanying drawings and described below. In the drawings:

FIG. 1 is a perspective view of an embodiment of a shelving system with solid shelving, mounted to a wall.

FIG. 2 is a perspective view of an embodiment of a shelving system with wire shelving, mounted to a wall.

FIG. 3 is a perspective view of embodiment of a hanger rod support apparatus, as shown in FIGS. 1 and 2.

FIG. 4 is an exploded perspective view of the hanger rod support apparatus as shown in FIG. 3.

FIGS. 5-7 are perspective, side, and front views of an embodiment of a plate incorporated in the hanger rod holder of FIG. 3.

FIG. 8 is detailed side view of the upper portion of the plate of FIGS. 5-7.

FIG. 9 is a front right perspective view of the hanger rod holder as shown in FIG. 3.

FIG. 10 is a front left perspective view of the hanger rod holder as shown in FIG. 3.

FIG. 11 is a right side view of the hanger rod holder as shown in FIG. 3.

FIG. 12 is a left side view of the hanger rod holder as shown in FIG. 3.

FIG. 13 is a rear view of the hanger rod holder as shown in FIG. 3.

FIG. 14 is a front view of the hanger rod holder as shown in FIG. 3.

FIG. 15 is a top view of the hanger rod holder as shown in FIG. 3.

FIG. 16 is a bottom view of the hanger rod holder as shown in FIG. 3.

FIG. 17 is a section view of the hanger rod holder taken along line 17-17 of FIG. 15.

FIG. 18 is a left side view of the bracket shown in FIG. 3.

FIG. 19 is a bottom view of the bracket shown in FIG. 3.

### DETAILED DESCRIPTION

Certain terminology is used herein for convenience only and is not to be taken as a limitation on the embodiments described. For example, words such as “top”, “bottom”, “upper,” “lower,” “left,” “right,” “horizontal,” “vertical,” “upward,” and “downward” merely describe the configuration shown in the figures. Indeed, the referenced components may be oriented in any direction and the terminology, therefore, should be understood as encompassing such variations unless specified otherwise.

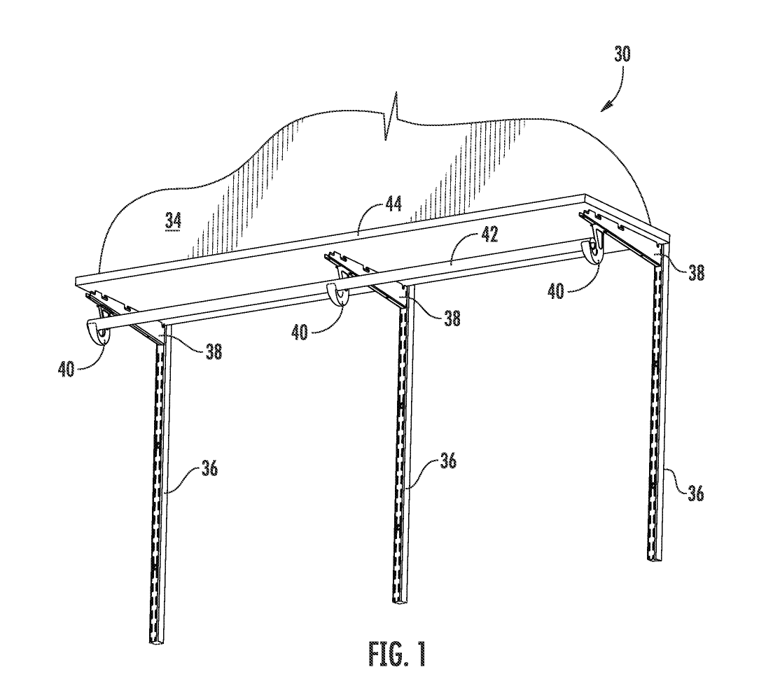

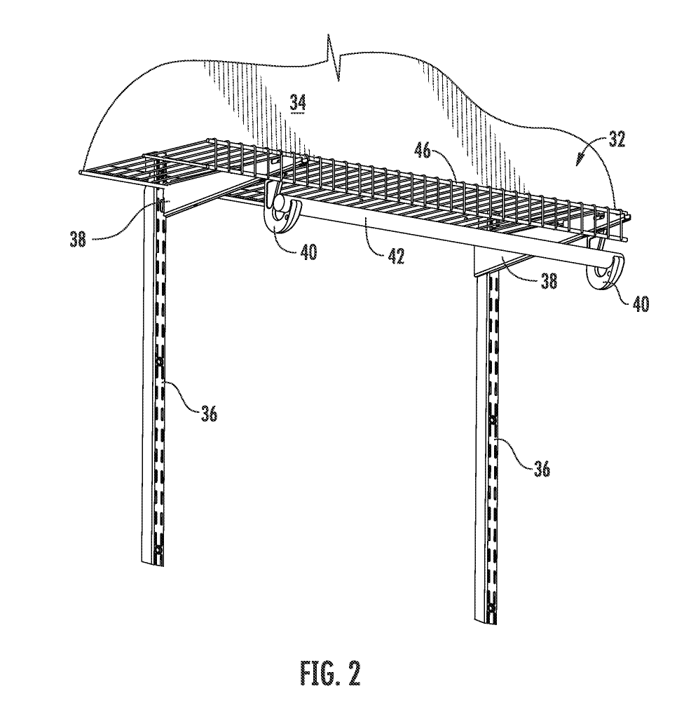

Referring now to the drawings, wherein like reference numerals designate corresponding or similar elements throughout the several views, embodiments of a shelving system are shown in FIGS. 1 and 2, and are generally designated at 30 and 32, respectively. The systems 30, 32 are shown mounted to a wall 34, though other mounting configurations, such as to posts or poles, are possible. The systems 30, 32 include mounting strips 36 fastened to the wall 34, brackets 38 mounted to the mounting strips 36, hanger rod holders 40, and a hanger rod 42. The brackets 38 can be placed at various positions in the mounting strips. The shelving system 30 of FIG. 1 includes a solid shelf 44, such as wood, while the shelving system of FIG. 2 includes a wire shelf 46. In addition to having the capability of being applied with a variety of shelf types, different lengths of hanger rods may be supported by adding brackets 38 and hanger rod holders 40 along the rod 42, as may be seen in FIG. 1, where there are three brackets 38 and holders 40, as compared to the shelving system of FIG. 2, where there are only two brackets 38 and holders 40.

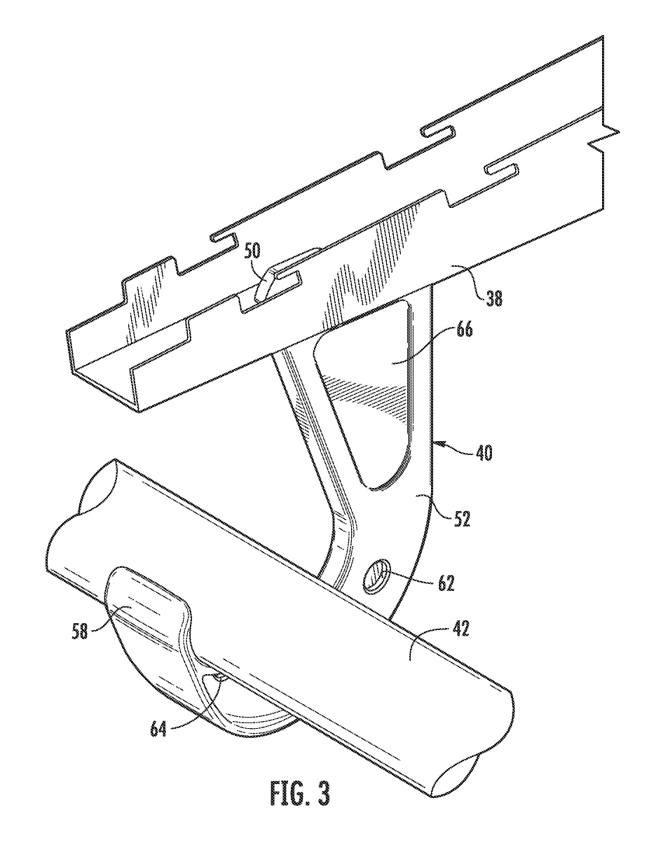

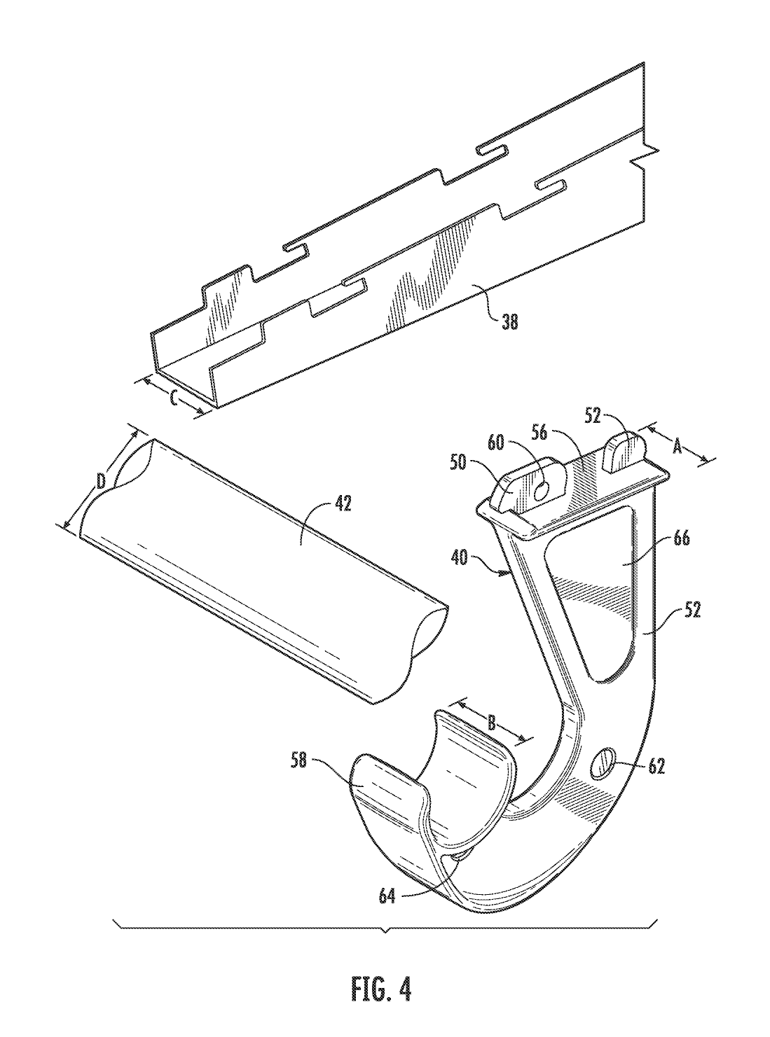

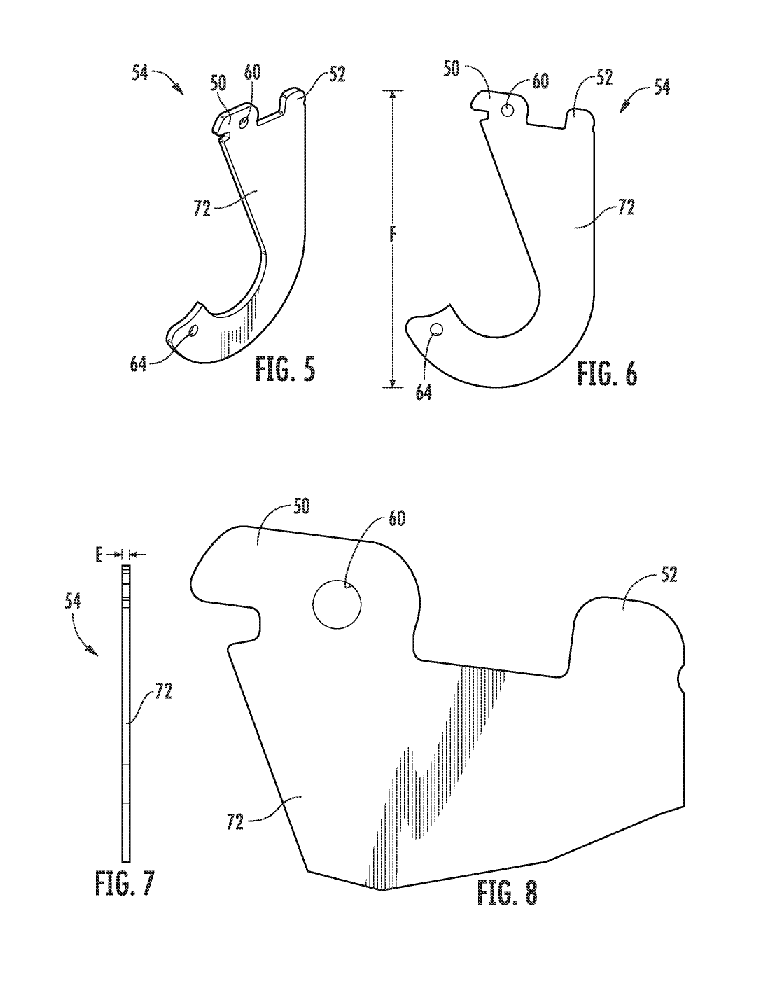

FIGS. 3 and 4 show detail of an embodiment of a hanger rod support apparatus with a hanger rod 42. The apparatus includes a bracket 38 and a hanger rod holder 40 mounted to the bottom of the bracket 38. The holder 40 may be made of at least two materials, being in one embodiment a metal plate with molded plastic around it. Alternatively, the plate may be made of a high strength polymer, and may include carbon reinforcing. Mounting tabs 50, 52 extend upward at a top end of the holder 40 to pass through slots in the bottom of the bracket 38. The mounting tabs 50, 52 may be part of the plate 54 (FIGS. 5-8) that is substantially encapsulated in plastic. A top surface 56 of the holder 40 defines a width A substantially of plastic that engages the bottom surface of the bracket 38. This engagement width A helps to prevent lateral movement or wiggle of the holder 40 in the direction perpendicular to the length of the bracket 38. The body 52 of the holder 40 is substantially J-shaped. At the end of the holder 40 opposite the top surface 56 is a C-shaped end element 58 that receives the rod 42 along a cradle width B along the rod. The C-shaped end element 58 is resilient, such as may be formed of a plastic, preferably with the ability to flex that can provide for holding the rod 42 firmly, in some cases with a friction fit, and also for accepting rods of various diameters. The plastic of the end element may extend to the other end of the J-shaped body, up to the mounting tabs 50, 52. Holes 60, 62, 64 are provided that facilitate injection molding of plastic around the plate 54. Holes 60, 64 are used to locate the plate 54 in a die. Hole 62 is only through the plastic, not the plate 54, and allows holding the plate 54 to prevent bending in the molding process.

Exemplary dimensions for certain elements are shown in FIG. 4. In one embodiment, the engagement width A may be, for example, at least approximately 0.5 inches wide, such as between approximately 0.5 and 1.0 inches, and preferably, approximately 0.575 inches. In general, the engagement width A will not exceed the bracket width C, but may do so, or may be, for example, substantially the same as bracket width C. Cradle width B may be, for example, at least approximately 0.75 inches wide, such as between approximately 0.75 and 1.5 inches, and preferably, 0.816 inches. The thickness of the plastic on the body 52 of the holder 40 may be, for example, 0.22 inches, and the reduced thickness in the central area 66 of the body may be, for example, 0.165 inches. The reduced thickness of plastic in this central area 66 reduces the amount of plastic required for the holder 40, in a location where thick plastic is unnecessary. The dimensions discussed above may be varied as determined by one of ordinary skill in the art to meet various load requirements, bracket configurations, or rod diameters.

FIGS. 5-8 show the plate 54 that is substantially encapsulated in plastic, excluding the mounting tabs 50, 52 at the upper end. In one embodiment, the plate 54 is generally centrally located in the holder 40, and when the holder 40 is installed for use, the plate 54 and holder 40 are substantially vertical. The mounting tabs 50, 52 are integral and of unitary construction with the plate 54. The plate body 72 is shown to be substantially J-shaped, but may be other shapes as well. The plate may be of various thicknesses, which may depend on material and anticipated load, but using a low carbon steel the thickness E may be, for example, approximately 0.098 inches, and may be greater. Height F may be, for example, approximately 3.8 inches.

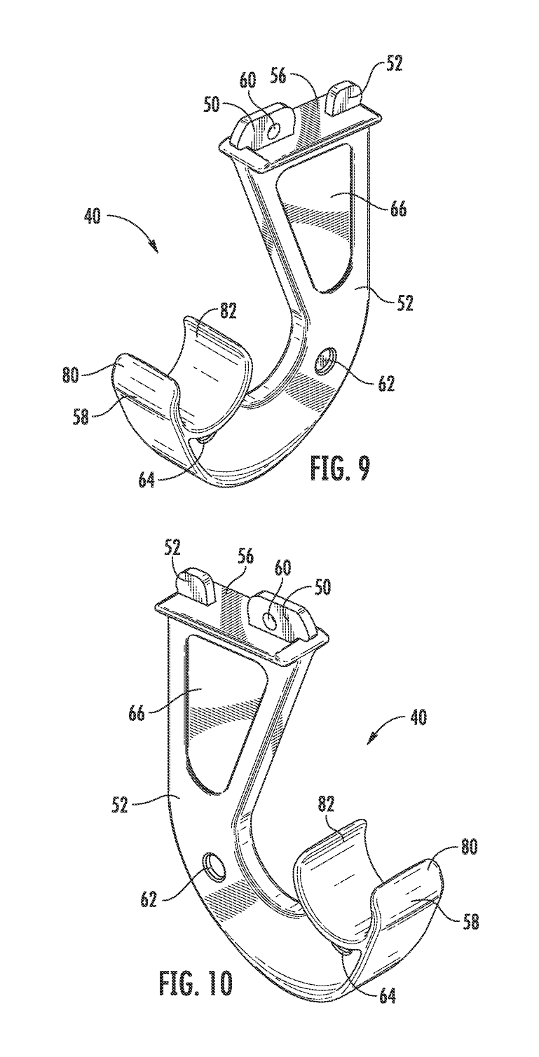

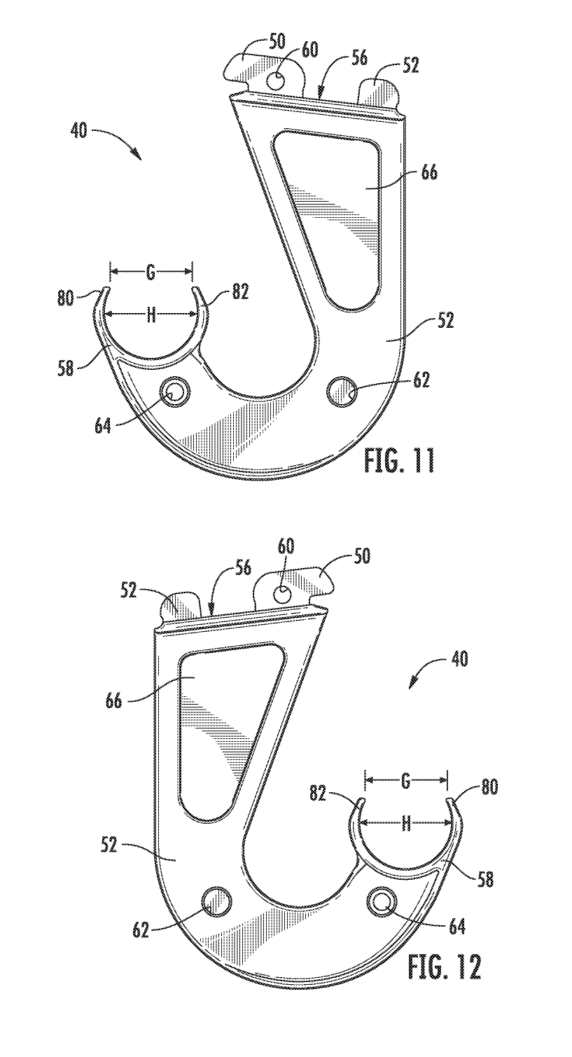

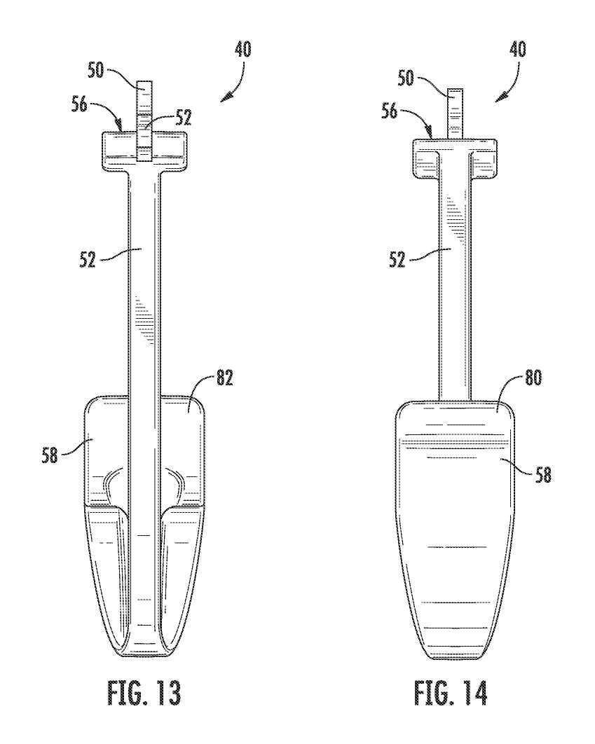

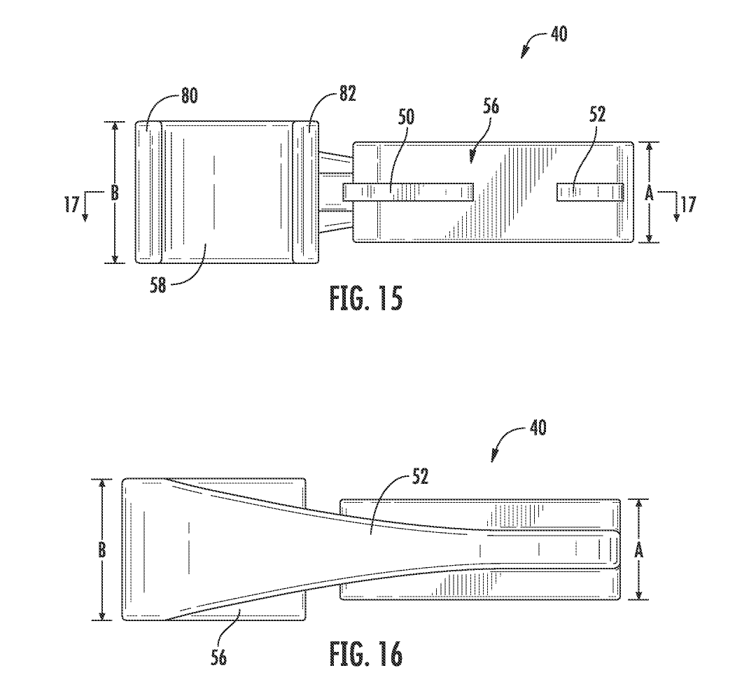

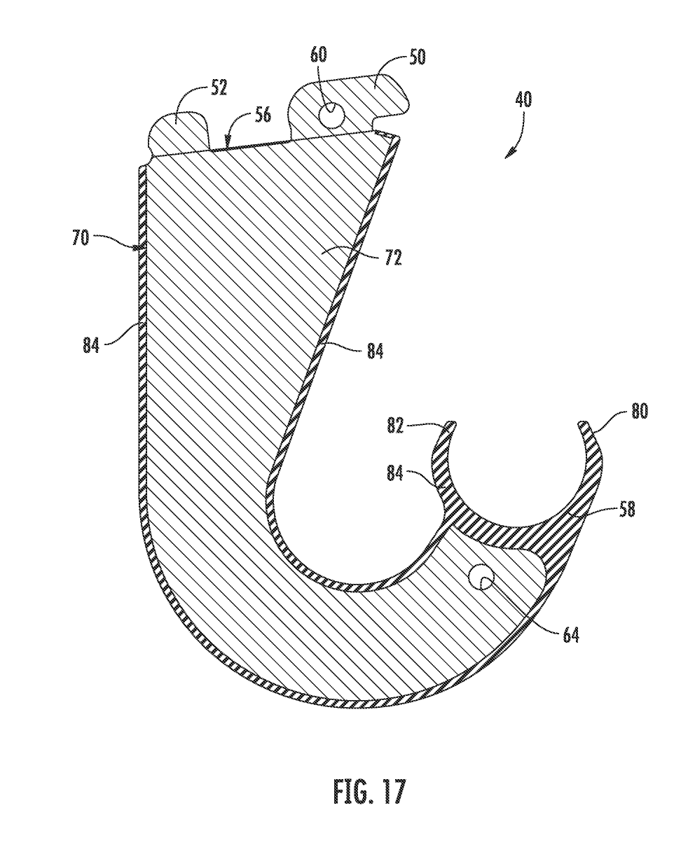

FIGS. 9-17 show the hanger rod holder in detail. As shown in FIGS. 11 and 12, the end element 58 includes two upwardly extending arms 80, 82. The two upwardly extending arms 80, 82 may be resilient plastic such that they flex, and have ends spaced by an opening of a width G smaller than the diameter D of the rod 42. The arms 80, 82 have an original position before the rod 42 is received in the end element 58 and a flexed position in which the arms 80, 82 are spaced apart farther than in the original position for allowing the rod 42 to pass through the opening. In the flexed position, the arms 80, 82 urge towards their original position once the rod 42 is received in the end element 58. In one embodiment, with the arms in their original position, without a rod 42 in place, the arms define the C-shape that has a diameter H of approximately 0.86 inches. The opening G between the ends of the arms 80, 82 may be, for example, approximately 0.75 inches. These dimensions may allow rods, for example, with diameters D (FIG. 4) of between approximately 0.875 inches and approximately 1.0 inch to be received in the end element 58 and held with a friction fit. In FIG. 17, the plate 54 may be seen within the body of the holder 40, with the body 72 of the plate 54 substantially or completely embedded in a different material, which may be plastic 84.

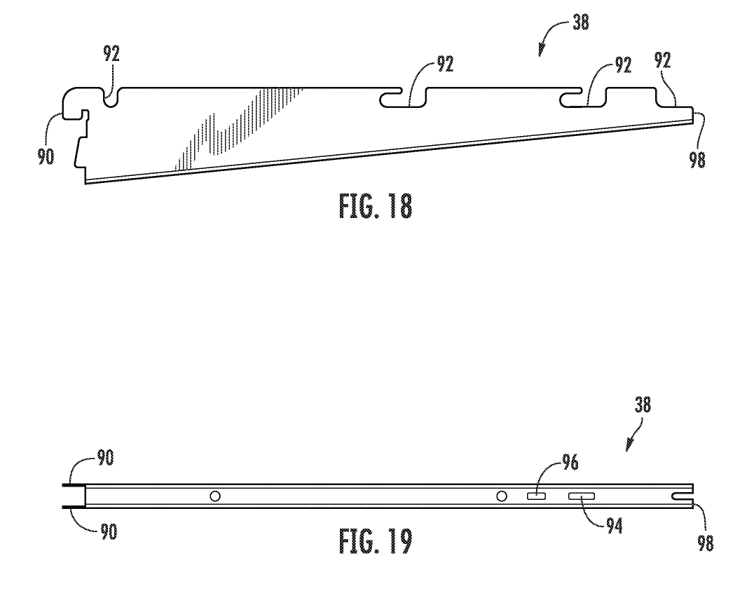

A shelf bracket 38 is shown in FIGS. 18 and 19. The bracket 38 mounts to mounting strips or other fixtures on a wall or other structure with mounting elements 90. Recessed areas 92 may be provided along the top of the bracket 38 to receive wire shelving 46. Alternatively, a solid shelf 44 such as wood may rest on top of the bracket without need for the recessed areas 92. On the bottom of the bracket there are openings 94, 96 to receive the mounting tabs 50, 52 of the holder 40. To mount the holder 40 to the bracket, the hook-shaped tab 50 is first inserted into the larger opening 94, and then the holder is slid toward the free end 98 of the bracket 38. The remaining tab 52 is then inserted into the smaller opening 96, which locks the holder 40 in place.

The materials of the hanger rod holder 40 may generally be expected to be metal and plastic. The plate may be, for example, a low carbon steel or other steel alloy, or a high strength polymer, and may include carbon reinforcing, but may be other metals or materials as selected by one of ordinary skill in the art. A surface treatment may be applied to the metal for corrosion protection, for example, a zinc coating by a barrel plating process, galvanizing, or a powder based paint coating, or as otherwise selected by one of ordinary skill in the art. The plastic may be molded plastic, including but not limited to homopolymer propylene, polypropylene, polyethylene, talc filled polypropylene (PP talc), polyvinyl chloride (PVC), polyoxmethylene (POM), styrene acrylonitrile (SAN), or other polymer. As previously discussed, the molded plastic may be formed by injection molding, as known by one of ordinary skill in the art. As an alternative, two pieces of plastic could be glued to the metal, with one piece on each side of the plate.

The combination of the metal and plastic materials in a hanger rod holder as described herein may result in a holder substantially resistant to deflection under a load, largely because of the strength of the metal. After a load is applied, there may be, for example, an initial period of deflection of the holder, with additional deflection over an extended period being substantially negligible. The plastic provides for a firm fit with both the bracket and the rod. The combination of materials may result in a holder that is stable vertically and laterally, as well as presenting an aesthetically pleasing appearance. By having a holder strong enough to mount to shelf brackets, a system may be provided that permits use of the holder and brackets with both wood and wire shelving.

Although the present invention has been shown and described in considerable detail with respect to only a few exemplary embodiments thereof, it should be understood by those skilled in the art that there is no intent to limit the invention to the embodiments since various modifications, omissions, and additions may be made to the disclosed embodiments without materially departing from the novel teachings and advantages of the invention, particularly in light of the foregoing teachings. For example, some of the novel features of the hanger rod holder could be applied to other types of rod support apparatus, whether related to hangers or otherwise. Accordingly, it is intended to cover all such modifications, omission, additions, and equivalents as may be included within the spirit and scope of the invention as defined by the following claims. In the claims, means-plus-function clauses are intended to cover the structures described herein as performing the recited function and not only structural equivalents but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures.

What is claimed is:

1. A holder for a rod comprising:
a plate made of a first material and including:
a plate body; and
mounting means extending from the plate body; and
a second material encapsulating the plate body and forming an end element configured to receive the rod.

2. The holder of claim 1, wherein the first material comprises metal or a high strength polymer, and the second material comprises plastic.

3. The holder of claim 2, wherein the metal comprises steel and the plastic comprises molded plastic.

4. The holder of claim 3, wherein the steel is at least partly zinc coated.

5. The holder of claim 3, wherein the molded plastic is selected from the group comprising homopolymer propylene, polypropylene, polyethylene, talc filled polypropylene (PP talc), polyvinyl chloride (PVC), polyoxmethylene (POM), styrene acrylonitrile (SAN), or other polymer.

6. The holder of claim 1, wherein the plate body is substantially J-shaped.

7. The holder of claim 1, wherein the end element is C-shaped with two resilient arms having ends spaced by an opening adapted to be smaller than the diameter of the rod.

8. The holder of claim 7, wherein the two arms are adapted to have an original position before the rod is received in the end element and a flexed position in which the arms are spaced apart farther than in the original position for allowing the rod to pass through the opening, wherein in the flexed position the arms are adapted to urge towards their original position once the rod is received in the end element.

9. The holder of claim 7, wherein the second material proximate to the mounting means is at least approximately 0.5 inches wide, and wherein the end element is at least approximately 0.75 inches wide in the direction the rod extends once the rod is received in the end element.

10. The holder of claim 1, wherein the mounting means includes a tab adapted to be received in an opening defined by a bracket.

11. A support apparatus for a rod comprising:
a bracket defining an opening, the bracket adapted to be mounted to a wall; and
a holder including:
a plate made of a first material and including:
a plate body; and
mounting means extending from the plate body and adapted to be received in the opening in the bracket; and
a second material encapsulating the plate body and forming an end element configured to receive the rod.

12. The support apparatus of claim 11, wherein the bracket is adapted to be mounted to a wall by mounting the bracket to a fixture that is mounted to the wall.

13. The support apparatus of claim 11, further comprising a shelf adapted to be supported by the bracket.

14. The support apparatus of claim 11, wherein the bracket and holder may be used to support a rod for a support apparatus that includes a solid shelf and for a support apparatus that includes a wire shelf

15. The support apparatus of claim 11, wherein the first material comprises metal or high strength polymer, and the second material comprises molded plastic.

16. The support apparatus of claim 10, wherein the end element is C-shaped with two resilient arms having ends spaced by an opening adapted to be smaller than the diameter of the rod.

17. The support apparatus of claim 16, wherein the two arms are adapted to have an original position before the rod is received in the end element and a flexed position in which the arms are spaced apart farther than in the original position for allowing the rod to pass through the opening, wherein in the flexed position the arms are adapted to urge towards their original position once the rod is received in the end element.

18. The support apparatus of claim 11, wherein the second material proximate to the mounting means is at least approximately 0.5 inches wide, and wherein the end element is at least approximately 0.75 inches wide in the direction the rod extends once the rod is received in the end element.

19. A method of making a rod holder, the method comprising:
providing a plate having a body and mounting means extending from the body; and
molding plastic to encapsulate the body of the plate and to form an end for receiving the rod.

20. The method of claim 19, wherein the end for receiving the rod includes a C-shaped element.
